(19) United States
(12) Patent Application Publication
(10) Pub. No.: US 2014/0237889 A1
(43) Pub. Date: Aug. 28, 2014

(54) FISHING LURE WITH MECHANISM FOR FISH HOOK REPLACEMENT

(71) Applicant: 100 Penn Drive, Unit 8 WestonM9L 2A9, Weston (CA)

(72) Inventor: Michael Tamburro, Toronto (CA)

(21) Appl. No.: 14/352,505

(22) PCT Filed: Oct. 19, 2012
(86) PCT No.: PCT/CA2012/000959

§ 371 Date: Apr. 17, 2014

Related U.S. Application Data
(63) Continuation-in-part of application No. 13/276,958, filed on Oct. 19, 2011.

(51) Int. Cl. A01K 85/00; A01K 91/04

(52) U.S. Cl. CPC A01K 85/00; A01K 91/04
USPC 43/42.09

(57) ABSTRACT

A fishing lure consists of a body portion having a line tying means on the body portion and means on the body portion for replaceable attachment of one or more hooks. In one embodiment a wire extends through the body portion of the lure and has a line tying section and a twist section. The line tying section is at one end portion of the wire. At least a portion of the line tying section, to which a fishing line is replaceably attached either directly or indirectly, protrudes from the lure. A twist section is at another end portion of the wire opposite to the one end portion with the line tying section. At least a portion of the twist section, to which a fish hook is replaceably attached, protrudes from the lure.

### FIELD OF THE INVENTION

The present invention relates to a lure used in fishing.

### BACKGROUND OF THE INVENTION

In the field of fishing equipment, companies such as Owner, Mustad, and Northland are well known as manufacturers of conventional fishing lures including fishing jigs, crank baits, spinnerbaits etc. A fishing lure is an object attached to the end of a fishing line which is designed to resemble and move like the prey of a fish. The purpose of the lure is to use movement, vibration, and colour to catch the fish's attention so it bites the hook. Lures are equipped with one or more single, double, or treble hooks that are used to hook fish when they attack the lure. A fishing jig typically consists of a lead weight or sinker with a hook molded into it and covered by a soft body or other bait to attract fish. Most jigs are intended to create a jerky, vertical motion, as opposed to spinnerbaits which move through the water horizontally. Jigs are configured to be permanently attached to a fish hook and may be molded as one-piece. Accordingly, the hook does not move freely and independently from the jig. Thus, the manufacturers need to provide a specific hook for a specific jig, and a fisherman cannot flexibly change hooks of his choice for the jig of his choice, depending on the style of how and what the fisherman chooses to fish.

In addition, in such a configuration, once the hook becomes dull or damaged beyond repair, the jig must also be discarded. Further, because the hook does not move freely and independently from the jig, a fish can get leverage on the jig to throw and escape from the hook.

Therefore, in the conventional art, the above-discussed configuration of the lure cannot accommodate the creative nature of a fisherman to allow flexible arrangements. Also, such configuration does not allow the manufacturers to control costs and qualities of the lures and the hooks independently and effectively.

### SUMMARY OF THE INVENTION

A fishing lure according to the present invention consists of a body portion having a line tying means on the body portion and means on the body portion for replaceable attachment of one or more hooks.

In one embodiment the fishing lure comprises a jig having weighted body portion having a line tying means on the weighted body portion and means on the body portion for replaceable attachment of one or more hooks.

In one embodiment the jig includes at least one wire that is at least partially embedded in the weighted body portion of the jig. The wire provides the means on the body portion for replaceable attachment of one or more hooks and has an exposed twist section at an end portion of the wire. A portion of the twist section, to which one or more fish hooks can be replaceably attached, protrudes from the exterior surface of the weighted body portion of the jig. Where the jig is intended to have more than one replaceable hooks at different points on the weighted body portion more than one wire each having an exposed twist section can be provided. Another end of at least one wire may have an exposed line typing section to provide a line tying means on the weighted body portion. At least a portion of the line tying section, to which a fishing line is replaceably tied, protrudes from the head of the jig. Alternatively the line tying means can be independent of the wire that provides an exposed twist section at an end portion of the wire.

The body portion or head of the jig may have a means to prevent the point(s) of connection of the one or more hooks to the means on the body portion for replaceable attachment of one or more hooks from being fouled by weeds or other debris in the water. In an embodiment means to prevent the point(s) of connection of the one or more hooks to the means on the body portion for replaceable attachment of one or more hooks from being fouled comprises a wall on a surface of the jig, which surrounds the portion of the twist a section of the wire protruding from the jig. Alternatively, the fishing jig may have a shell that is at least partially embedded in the body portion of the jig to provide means to prevent the point(s) of connection of the one or more hooks to the means on the body portion for replaceable attachment of one or more hooks from being fouled by weeds or other debris in the water.

In one embodiment the twist section may have a wire end at the other end portion of the wire opposite to the one end portion with the line tying section. The twist section may also have a center portion between the line tying section and the wire end. The center portion of the twist section at least partially protrudes from the jig. A portion of the twist section between the center portion and the wire end is bent to go under the center portion of the twist section through a bottom side of the twist section and to have the wire end at a right side of the twist section.

### BRIEF DESCRIPTION OF THE DRAWINGS

A more complete appreciation of the invention and many of the intended advantages thereof will be readily obtained as the same becomes better understood by reference to the following detailed description when considered in connection with the accompanying drawings, wherein:

FIG. 1 is a perspective view that shows one embodiment of a fishing lure of the present invention in the form of a jig with a fish hook attached and a plastic worm attached to the hook.

FIG. 2 is a perspective view of the jig shown in FIG. 1 without the hook attached.

FIG. 3 is another perspective view of the jig shown in FIGS. 1 and 2, viewed from the rear side of the jig without the hook attached.

FIG. 4 is a view of a twist section of a wire of the jig shown in FIG. 3, viewed from the rear side of the twist section.

FIG. 5 is a view of the twist section of the wire of the jig shown in FIG. 4.

FIG. 6 is a view of the hook and the twist section of the wire of the jig shown in FIGS. 3-5.

FIG. 7 is a front view of another embodiment of a fishing lure of the present invention in the form of a jig.

FIG. 8 is a rear view of the jig shown in FIG. 7.

FIG. 9 is a side view of the jig shown in FIGS. 7 and 8.

FIG. 10 is a side view in cross section of the jig shown in FIG. 9.

FIG. 11 is a front view of yet another embodiment of a jig of the present invention.

FIG. 12 is a rear view of the jig shown in FIG. 11.

FIG. 13 is a side view of the jig shown in FIGS. 11 and 12.

FIG. 14 is a side view in cross section of the jig shown in FIG. 13.

FIG. 15 is a front view of yet another embodiment of a jig of the present invention.

FIG. 16 is a rear view of the jig shown in FIG. 15.

FIG. 17 is a side view of the jig shown in FIGS. 15 and 16.

FIG. 18 is a side view in cross section of the jig shown in FIG. 17.

### DETAILED DESCRIPTION OF THE INVENTION

Various embodiments will now be described with reference to the accompanying drawings, wherein like reference numerals designate corresponding or identical elements throughout the various drawings. It is noted that the scope of the present invention is not limited to the embodiments shown in the accompanying drawings.

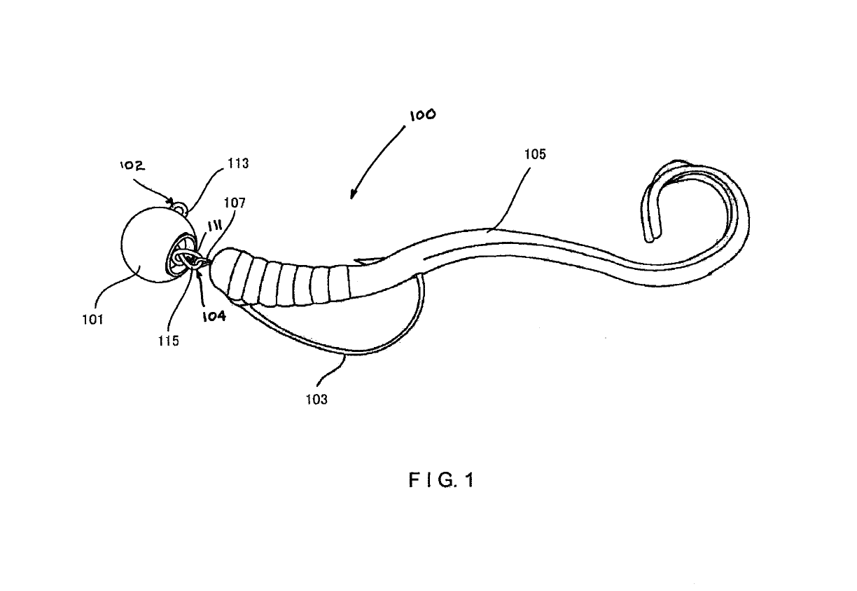

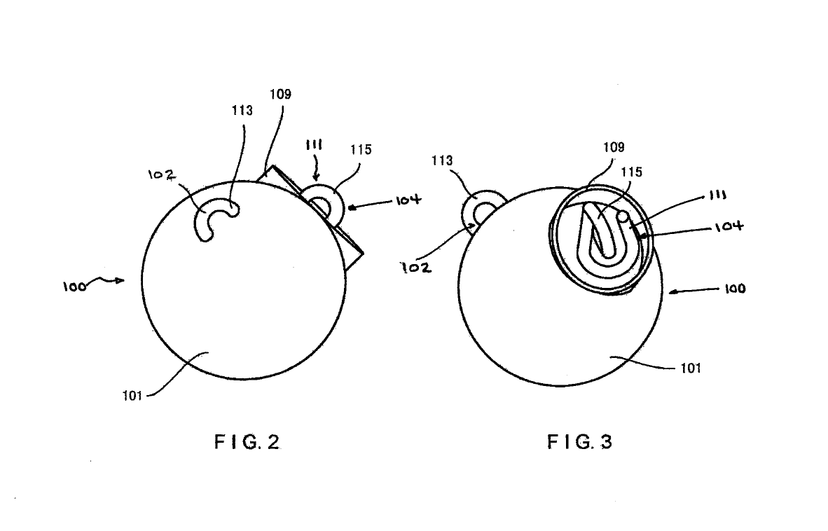

FIG. 1 is a perspective view that shows one non-limiting embodiment of a fishing lure in the form of a jig, generally indicated at 100, according to the present invention. FIG. 2 is a perspective view of the jig 100. The jig 100 in this embodiment, for example, has a weighted body portion 101 in the form of a ball shaped weighted head. The jig 100 includes a line tying means, generally indicated at 102 on the head 101 and means, generally indicated at 104 on the head 101 for replaceable attachment of one or more hooks. In FIG. 1 one hook 103 is illustrated. The means 104 for replaceable attachment of one or more hooks can have different designs so long as it enables the fisherman to detach and attach different sizes of hooks, allows the hook to move freely and independently from the lure and prevents a fish from getting leverage on the lure to throw and escape from the hook. In the embodiment illustrated in FIGS. 1-5, the means 104 for replaceable attachment of one or more hooks comprises a wire, generally indicated at 111, extending from the head 101 of jig 100. At an exposed end portion of the wire 111, the end of the wire 111 is configured to make a twist section 115 and thereby form means 104 for replaceable attachment of one or more hooks. A fish hook 103 has an eyelet 107 that is replaceably attached to the twist section 115 of the wire 111. Also, bait in the form of a plastic worm 105 is shown attached to the hook 103 although other forms of bait whether artificial or natural are within the scope of the present invention. The hook 103 may be of different sizes and shapes to accommodate the fisherman's preferences. In addition the size, shape and weight of the head of the jig can be varied.

In the embodiment illustrated in FIGS. 1-5, the wire 111 is utilized to provide the line tying means 102 on the body portion 101 of the jig. The other end portion of the wire 111 from the twist portion 115 is exposed from the head 101 of the jig, so the end of the wire 111 forms a closed loop 113 to create a line tying means 102. Rather than using a closed loop 113 on wire 111, the line tying means 102 can be formed from a separate wire extending from the body portion 101 or other form of closed loop affixed to the body portion by an adhesive or fastener or even a hole in the body portion through which the fishing line can directly or indirectly be connected to the lure.

The wire 111 of the jig 100 in FIGS. 1-5 may have a rating of 100 lbs.-1000 lbs. and may be made of, for example, stainless steel, titanium etc. that is water resistant and can withstand heat when the body portion is made from molten lead, bismuth, tin, tungsten or any other metal. The body portion can be made of other materials such as wood or plastic or combination of materials. The wire 111 is at least partially embedded in the head or body portion 101 of the jig 100 with the line tying section 113 at least partially exposed at one point on the surface of the body portion 101 of jig 100 and the twist section 115 at least partially exposed at another point on body portion of the jig 100.

FIG. 3 is another perspective view of the jig 100 viewed from the rear side of the head or body portion 101 of the jig 100. The head 101 of the jig 100 may be provided with means to prevent the point(s) of connection of the one or more hooks to the means on the body portion for replaceable attachment of one or more hooks from being fouled by weeds or other debris in the water. In FIGS. 1-5 the body portion 101 has a recessed area at which the twist section 115 of wire line 111 is exposed, surrounded by a wall 109. The end of the wire 111 containing the twist section 115 protrudes from the head 101 of the jig 100 within the recessed portion surrounded by wall 109. The recessed portion and surrounding wall 109 are sized and shaped to permit hooks of different sizes and shapes to replaceably attach to the twist section 115 and prevent the hook 103 from turning over on itself or getting fouled up.

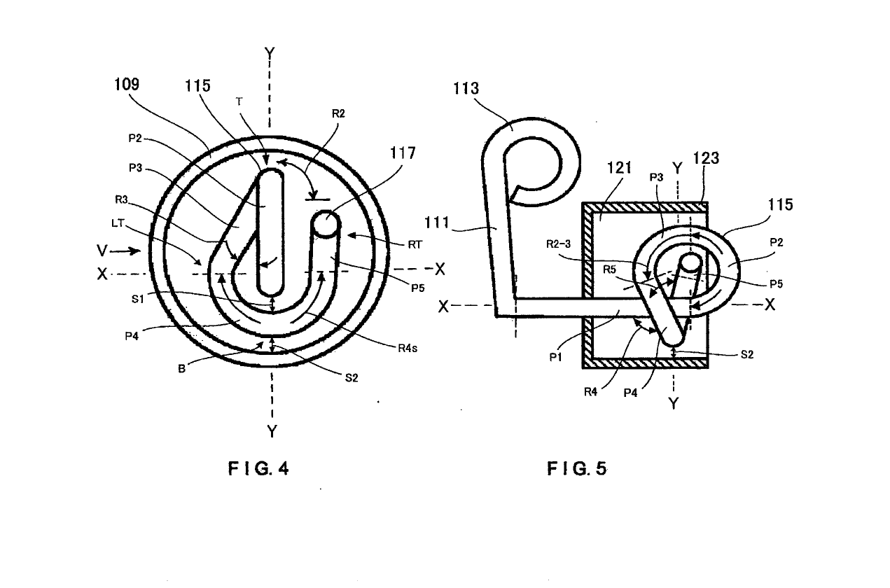

FIGS. 4 and 5 show how the twist section 115 of the wire 111 can be configured to provide a mechanism for fish hook replacement. FIG. 4 shows the rear side view of the twist section 115 in a substantially correct proportional relation when the hook 107 is attached properly. FIG. 5 shows a left side view of the twist section 115 shown in FIG. 4 (i.e. viewed from a direction indicated by arrow V) in a substantially correct positional relation.

As shown in FIGS. 4 and 5, the twist section 115 of the wire 111 in the embodiment illustrated is a single wire, which is divided into five portions P1-P5 for the purpose of ease of explanation and illustration (i.e., The five portions P-1-P5 are physically connected seamlessly as a single wire in the embodiment shown but could in other cases be two separate wires or more if multiple hooks are to be attached). The portion P1 of the twist section 115 is a center portion of the wire 111 which is closer to the line tying section 113 than other portions P2-P5 of the twist section 115. The portion P5 is the end portion of the wire 111 opposite to the end portion where the line tying section 113 is formed. The portion P5 has a wire end 117 at the end of the twist section 115. Also, the twist section has top side T, bottom side B, right side RT, and left side LT.

The portion P1 of the twist section 115 protrudes from a surface of the head or body portion 101 of jig 100 at one point on the head 101. Then, the portion P2 of the twist section 115 is bent into a half circle toward the top side T at an angle R2 in relation to horizontal plane X-X. In this non-limiting embodiment shown in FIGS. 4 and 5, the angle R2 is, for example, approximately 90 degrees along vertical axis Y-Y. Then, the portion P3 of the twist section 115 is bent away from vertical axis Y-Y. The angle R3 is preferably in a range between 25 degrees and 35 degrees. In this non-limiting embodiment shown in FIGS. 4 and 5, the angle R3 is, for example, approximately 30 degrees.

As the portion P3 of the twist section 115 bends away at the angle R3, it is also bent so that the portion P4 extends toward the bottom side B at angle R4 in relation to horizontal plane X-X. the angle R4 is preferably in a range between 90 and 135 degrees. In this non-limiting embodiment shown in FIGS. 4 and 5, the angle R4 is, for example, approximately 112 degrees. Also, the combined portions of P2 and P3 makes a turn along vertical axis Y-Y, at angle R2-3. The angle R2-3 is preferably in a range between 235 degrees and 360 degrees. In this non-limiting embodiment shown in FIGS. 4 and 5, the angle R2-3 is approximately 297 degrees.

The portion P4 of the twist section 115 is then bent at angle R4s going under the portion P1 of the twist section 115 through the bottom side B toward the right side RT. The angle R4s is preferably in a range between 145 degrees and 215 degrees. In this non-limiting embodiment shown in FIGS. 4 and 5, the angle R4s is, for example, approximately 180 degrees. A space S1 between the portion P1 and the portion P4 of the twist section 115 is such that a small snap is required when the eyelet 107 of the hook 103 passes around the twist section 115 through the space S1. The space S1 provides added security to the hook 103 from being thrown by a hooked fish.

Further, as shown in FIGS. 4 and 5, as the twist section 115 makes a return at the angle R4s, the wire end 117 of the twist section 115 finishes at angle R5 in relation to horizontal plane X-X, leaning slightly forward. The angle R5 is preferably in ranges between 80 degrees and 125 degrees. In this non-limiting embodiment shown in FIGS. 4 and 5, the angle R5 is, for example, approximately 102 degrees. As shown in FIG. 4, when the twist section 115 of the wire 111 is viewed from the rear of the head 101 of jig 100, the wire end 117 is on the right side RT with the bend going under the wire to the left side LT.

As an alternative to the above-explained configuration of the twist section 115, the twist section may have a configuration with a mirror image of the above-explained configuration.

In this non-limiting embodiments shown in FIGS. 4 and 5, the wire 111 may be directly embedded in the head or body portion 101 of jig 100. Alternatively, in order to, for example, ease the manufacturing process, a shell 121 may be embedded in the head or body portion 101 of jig 100 to create a cavity in the head 101 of jig 100 for a part of or all of the wire 111 to be placed in the cavity in the head 101 of the jig 100. The shell 121 may be made of, for example, metal such as tungsten or brass, which can withstand heat from the molten metal of the body portion when made from metal or when the body portion is made from other materials the shell can be formed separately or integral with the body portion of the same material. The shell 121 may have a protruded shell wall 123 that replaces the wall 109 of the recess in the head of the jig and protrudes from the surface of the jig 100.

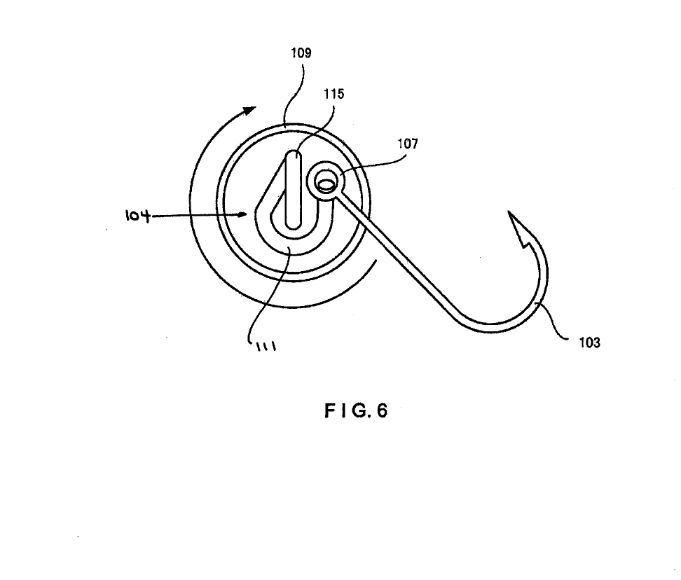

FIG. 6 shows how the hook 103 is installed to the twist section 115 of the wire 111 through the eyelet 107 of the hook 103. A clearance space S2 between the wire 111 and the wall 109 of the recess (see FIG. 4) or shell wall 123 of shell 121 (see FIG. 5) in the head of the jig should be tight enough for the eyelet 107 to just pass by. If the shell is used in the jig 100 and the protruded shell wall 123 replaces the wall 109 of the recess in the head of the jig, the clearance space S2 between the twist section 115 and the protruded shell wall 123 of the jig 100 should be tight enough for the eyelet 107 of the hook 103 to just pass by and then sit in place.

In this embodiment shown in FIGS. 1-6, the twist section 115 is configured in such a way for the fisherman to be able to put the eyelet 107 of the hook 103 on the wire end 117 of the twist section 115 with the hook 103 in a final desired orientation. Such a configuration enables the hook 103 to end up in the same orientation as the hook 103 was in when first entered into the twist section 115, since the hook 103 rotates 360 degrees as the eyelet 107 is led through the twist section 115.

The twist section 115 may be used on lures of most types and sizes. In addition, in the embodiment illustrated the line tying section 113 of the wire 111 is configured to give the wire 111 a sufficient strength, eliminating a possibility of a line tie to pull out when the fish is hooked or when the hook 103 and/or the jig 100 is caught on a rocky bottom.

Further, in this embodiment shown in FIGS. 1-6, because the jig 100 is configured as described above, the hook 103 moves independently to the body portion or head 101 of jig 100, giving the fish a new action not seen before with plastic lures, or live or natural bait, on conventional one-piece rigid jig head and hook combos.

Moreover, because the jig 100 is configured as described above, it minimizes a possibility that the fish bends or stretches out the wire 111 and the twist section 115 of the wire 111 when the fish is hooked. The jig 100 is configured in such a way that the wire 111 and the twist section 115 of the wire 111 tighten on the hook 103 instead of letting go or stretching out.

In the present invention, the lure or jig 100 allows the fisherman to have this jig 100 as a universal and standard jig in most tackle boxes. A manufacturer of the jig 100 does not need to provide the hook 103 and the fisherman can change the style of how he/she fishes, with a different style of hook. Now this jig 100 provides the fisherman with flexibility to respond to the creative nature of the fisherman, the water and/or weather conditions, and species he seeks.

Also, from a manufacturing stand point, costs of manufacturing a quality hook affect the actual costs of manufacturing a fishing lure when the hook is permanently integrated in the fishing lure together with a jig. With the jig 100 of the present invention, the fisherman can just replace the hook 103 and he can be back fishing while saving time and money.

Accordingly, the lure or jig 100 of the present invention gives the fisherman a quality jig with the mechanism that can be used with any hook he desires and provides.

The mechanism for flexible fish hook replacement described above on the jig 100, which is a ball or round jig, may be applied on different types of lures such as a simple ball jig, a football jig, a swim head jig, a weed-less jig, a flipping jig, spinnerbaits, crankbaits (plug) etc.

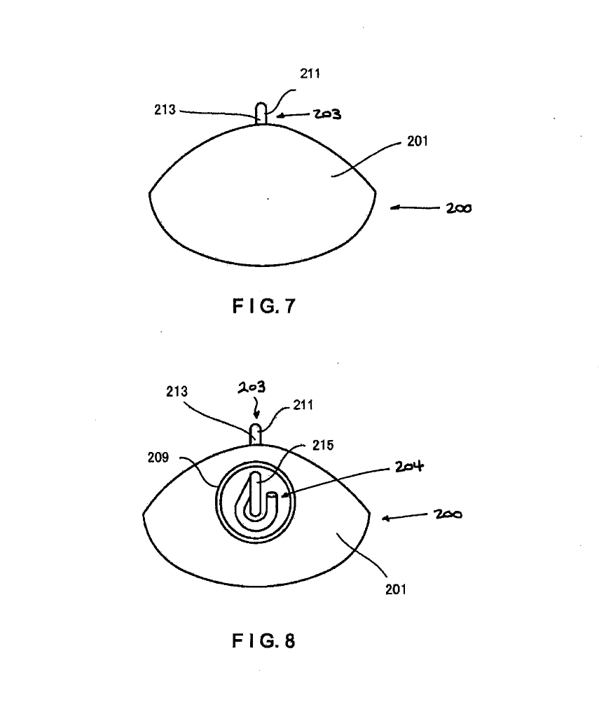

FIGS. 7-10 show another embodiment of the present invention, which is a lure in the form of a jig 200 with a weighted football shaped head 201 having a line tying means generally indicated at 203 on the head and means generally indicated at 204 on the head for replaceable attachment of one or more hooks. FIG. 7 is a front view of the football shaped head 201 of jig 200. FIG. 8 is a rear view of the football shaped head 201 of jig 200. The football shaped head 201 has a line tying means 203 in the form of a wire 211 having a line tying section 213 at one end portion of the wire 211, and means 204 at another end of the head for replaceable attachment of a hook in the form of a twist section 215 at another end portion of the wire 211. The football shaped head 201 of jig 200 has a recess with a wall 209 that surrounds the twist section 215. The wall 209 and recess form means to prevent the point(s) of connection of the one or more hooks to the means on the body portion for replaceable attachment of one or more hooks from being fouled by weeds or other debris in the water.

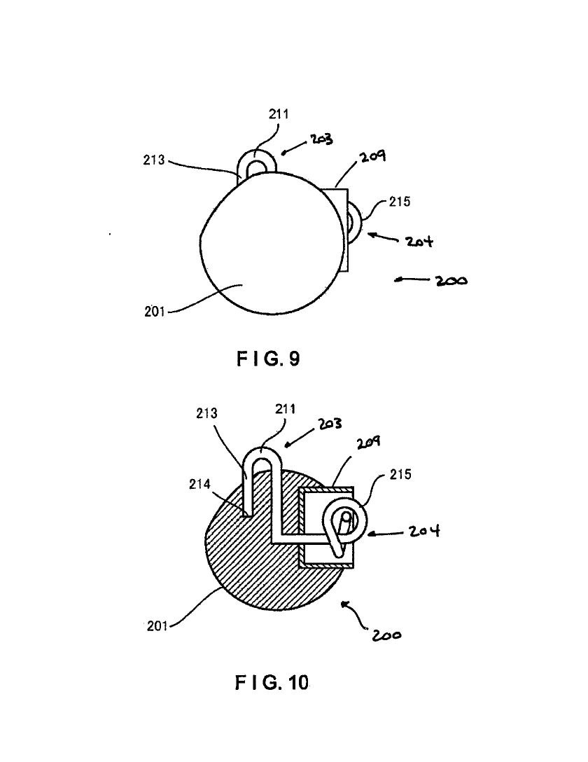

FIG. 9 is a side view of the football shaped head 201 of jig 200, showing the line tying section 213 at least partially exposed from a side of the football shaped jig 201, and the twist section 215 of the wire 211 at least partially exposed from the football shaped head 201 of jig 200. FIG. 10 shows how the wire 211 is configured for the football shaped head 201. The line tying section 213 is bent into a “U” shape with a wire end 214 embedded within the football shaped head 201. The wire 211 may be made of, for example, stainless steel.

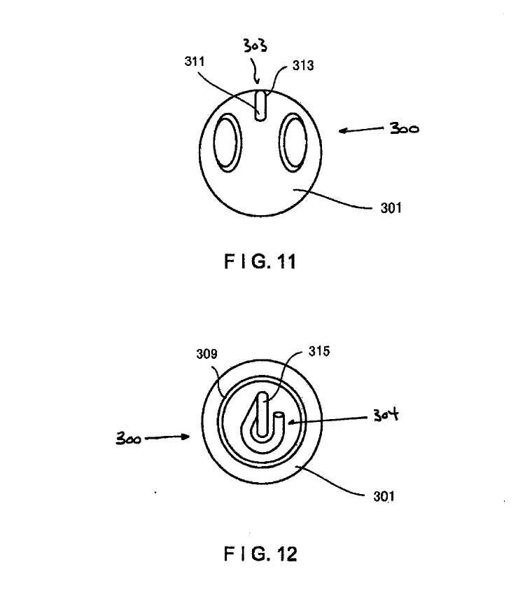

FIGS. 11-14 show another embodiment of a lure according to the present invention, which is a swim jig 300 having a weighted head 301 and having a line tying means generally indicated at 303 on the head 301 and means 304 on the head 301 for replaceable attachment of at least one hook. FIG. 11 is a front view of the swim jig 300. FIG. 12 is a rear view of the swim jig 300. The swim jig 300 has a wire 311 with one end forming a line tying a line tying means 303 by the section 313, and means 304, at another end of the wire 311, for replaceable attachment of one or more hook(s) in the form of a twist section 315. The swim jig 300 has a recess with a wall 309 in the head 301 that surrounds the twist section 315 thereby forming means to prevent the point(s) of connection of the one or more hooks to the means on the body portion for replaceable attachment of one or more hooks from being fouled by weeds or other debris in the water.

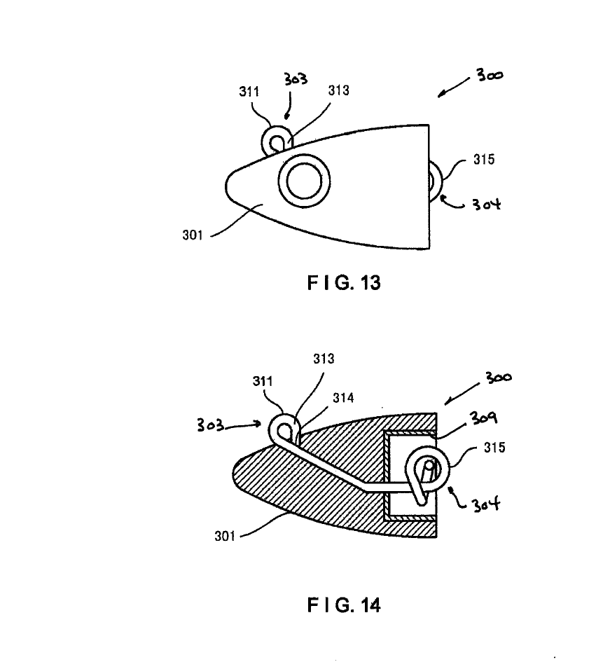

FIG. 13 is a side view of the swim jig 300, showing the line tying section 313 at least partially exposed from the head 301 of swim jig 300, and the twist section 315 of the wire 311 at least partially exposed from the head 301 of swim jig 300.

FIG. 14 is a side view in cross section of the swim jig 300. FIG. 14 shows how the wire 311 is configured for the swim jig 300. The line tying section 313 is bent into a mini-circle shape with a wire end 314 embedded within the head 301 of swim jig 300. The wire 311 may be made of, for example, stainless steel.

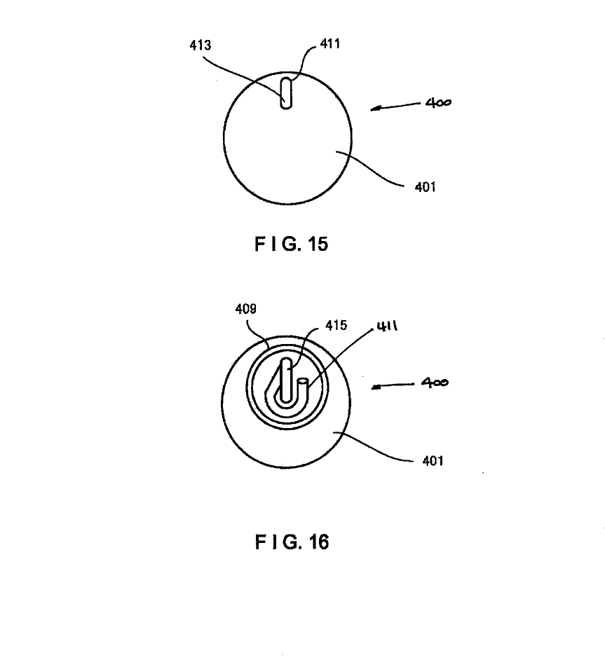

FIGS. 15-18 show another embodiment of a lure according to the present invention, a weed-less jig 400 having a head or body portion 401. FIG. 15 is a front view of the head or body portion 401 of weed-less jig 400. FIG. 16 is a rear view of the weed-less jig 400. The weed-less jig 400 has a wire 411 having a line tying section 413 at one end portion of the wire 411, and a twist section 415 at another end portion of the wire 411. The head 401 of the weed-less jig 400 has a recess with a wall 409 that surrounds the twist section 415.

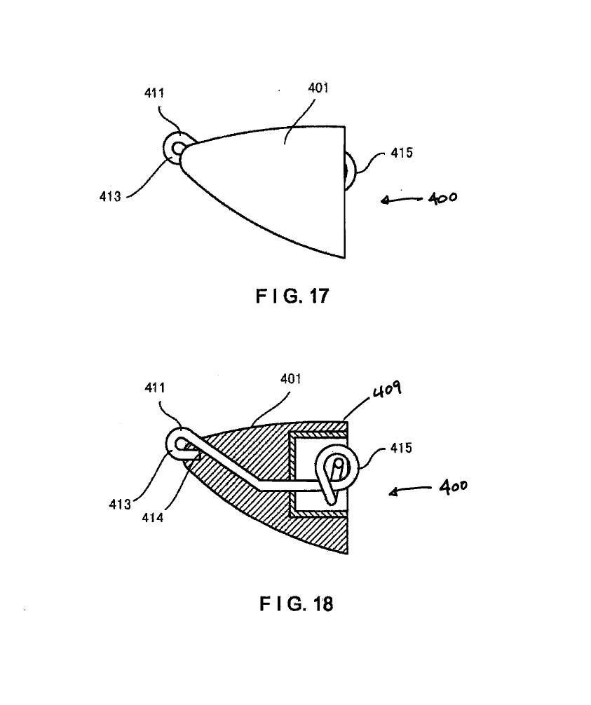

FIG. 17 is a side view of the weed-less jig 400, showing the line tying section 413 at least partially exposed from the head 410 of the weed-less jig 400, and the twist section 415 of the wire 411 at least partially exposed from the head 401 of the weed-less jig 401.

FIG. 18 is a side view in cross section of the weed less jig 400. FIG. 18 shows how the wire 411 is configured for the weed-less jig 400. The line tying section 413 is bent into a mini-tear drop shape with a wire end 414 embedded within the head 401 of weed-less jig 400. The wire 411 may be made of, for example, stainless steel.

Numerous modifications and variations of the present invention are possible in light of the above teachings. The means for replaceable attachment of one or more hooks can be applied to a wide variety of lures from jigs, crank baits or plugs, spinnerbaits etc. The body portion of the lure can be a single piece or made of two or more pieces with a fixed or jointed connection. Rather than using a wire having at twist section at one end as described, the means for replaceable attachment of one or more hooks, other types of fasteners can be used including snap links, interlock snaps, split rings etc that will provide for replaceable attachment of one or more hooks and allow the hooks to move freely and independently from the body portion of the lure. The number, shape and configuration of the hooks replaceable attached to the lure can vary. Where there are multiple hooks attached to the lure at least one of the hooks is replaceable attached in accordance with the present invention. It is therefore to be understood that within the scope of the appended claims, the invention may be practiced otherwise than as specifically described herein.

1-10. (canceled)

11. A fishing lure comprising a body portion having means attached to the body portion for replaceable attachment of one or more hooks wherein the means on the body portion for replaceable attachment of one or more hooks comprises a wire that is at least partially embedded in the body portion of the lure, the wire having a twist section at an end of the wire protruding from the body portion of the lure wherein the twist section has a first portion protruding from the body portion of the lure and having a longitudinal axis in a first plane, a second portion of the twist section adjacent the first portion bent at an angle to the longitudinal axis of the first portion, a third portion bent at an angle away from a longitudinal axis of the second portion and towards the first plane of the first portion, a fourth portion of the twist section extending from the third portion and bent below the longitudinal axis of the first portion of the twist section and a fifth portion of the twist section terminating at a wire end with the wire end above the longitudinal axis of the first portion.

12. A fishing lure according to claim 11 wherein the body portion is weighted.

13. A fishing lure according to claim 11 wherein when attached to the twist section, the one or more hooks are attached so that they move freely and independently from the body portion of the lure and the means for replaceable attachment of one or more hooks prevents a fish from getting leverage on the lure to throw and escape from the hook.

14. The fishing lure according to claim 11 wherein the second portion of the twist section is bent into a half circle and the third portion is continued being bent away from the vertical axis of the second portion at an angle in relation to the vertical axis of the second portion and towards the first plane of the first portion.

15. The fishing lure according to claim 11 wherein the fourth portion of the twist section extends from the third portion and bends under the first portion.

16. The fishing lure according to claim 15 wherein the fifth portion of the twist section terminating at the wire end finishes at an angle in relation to the longitudinal axis of the first portion.

17. The fishing lure according claim 11 wherein clearance between the first portion and the fourth portion along an extension of the vertical axis of the second portion is less than the thickness of an eye of a hook being placed on the lure but permits the eye of the hook to pass around the twist section through the clearance between the first portion and the fourth portion.

18. A fishing lure according to claim 11 wherein a line tying means is provided on the body portion, the line tying means comprising a line tying section at an end portion of the wire remote from the twist section, at least a portion of which is protruding from the body portion of the lure, and to which a fishing line is directly or indirectly replaceably connected.

19. The fishing lure according to claim 11 wherein the twist section is located within a recessed area on the body portion and is surrounded by a peripheral wall of the recessed area.

20. The fishing lure according to claim 11 wherein the twist section extends from an outer surface of the body portion and is surrounded by a wall extending outwardly from the outer surface of the body portion.

21. The fishing lure according to claim 11 further comprising a shell configured to be at least partially embedded in the body portion of the lure to create a cavity in which the twist section is located.

22. The fishing lure according to claim 19 wherein minimum clearance between the twist section and the peripheral wall is tight enough for an eyelet of a hook to just pass by.

23. The fishing lure according to claim 20 wherein minimum clearance between the twist section and the wall is tight enough for an eyelet of a hook to just pass by.

24. The fishing lure according to claim 21 wherein minimum clearance between the twist section and the shell is tight enough for an eyelet of a hook to just pass by.

25. A fishing lure according to claim 11 is a jig, crank bait or spinner bait.

26. A fishing lure according to claim 25 in the form of a jig.
